(19) United States
(12) Patent Application Publication
(10) Pub. No.: US 2007/0259804 A1
(43) Pub. Date: Nov. 8, 2007

(54) Method and Device for the Production of a Solid Fragrance

(76) Inventors: Raymond J. Heinz, Leipzig (DE); Hans-Jurgen Huppert, Leipzig (DE); Collin Berrido, Bagshot (DE)

Correspondence Address: WILLIAM COLLARD;COLLARD & ROE, P.C., 1077 NORTHERN BOULEVARD, ROSLYN, NY, 11576, US

(21) Appl. No.: 11/666,589

(22) PCT Filed: Sep. 29, 2005
(86) PCT No.: PCT/EP05/10505

§ 371 Date: May 23, 2007

(30) Foreign Application Priority Data
Oct. 29, 2004 (DE) 10 2004 052 929.9

(51) Int. Cl. C11D 3/50; C11B 9/00

(52) U.S. Cl. 512/4

(57) ABSTRACT

The invention relates to a method for producing a solid odorous substance from at least one odorous substance that is liquid at normal temperature and at least one carrier material (6) that is solid at normal temperature. According to the method, the at least one fine-particle carrier material (6) is exposed to a spray mist (7) of at least one liquid odorous substance in a fluidised bed.

The invention concerns a method and a device for the production of a solid fragrance made of a liquid fragrance and a solid base material.

From the DE-OS 102 47 583 A1 a method is known for the production of a solid fragrance by dissolving a liquid fragrance in a thermally liquefied base material, which is solid at normal temperature, and by solidifying the fragrance-base material-solution and afterwardly cooling it to normal temperature. This method enables the dissolving of a high rate of fragrances (up to 60%) in the base material and to bring it to market as a solid fragrance with a good suitability for storage and transportation, mostly in the form of little fragrance chips or pearls, for further processing in the production of solid soaps, pulverized or granulated washing and washingup agents, scented objects etc.

The method mentioned before in which the liquid fragrance is brought into the heated liquid base material and afterwards it is subjected to a solidifying and modeling process for gaining the chip and pearl form, proves to be relatively complex and expensive. Apart from this it is a further disadvantage of the state of the art that in most cases the existing semi-manufactured product in the form of chips or pearls is not suitable for direct further processing, e.g. for mixing it with refined raw soap in the soap production process or for mixing it with pulverized washing and washingup agents, because for an even distribution of the solid fragrance in the end product it has to be subjected to a further processing, e.g. to milling or grinding.

Therefore, it is the main object of the invention to develop a method and a device for the production of a solid fragrance made of a liquid fragrance and a solid base material without changing the state of aggregation of the base material, and which enables the production of a solid fragrance in a pulverized or granulated form suitable for direct further processing.

The problem is solved by the characteristic features of the patent claims 1 and 7.

Favorable performances of the invention form the features of subclaims 2 to 6 and 8 to 12.

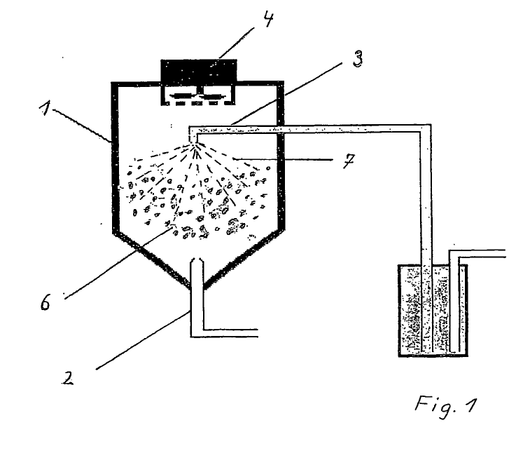

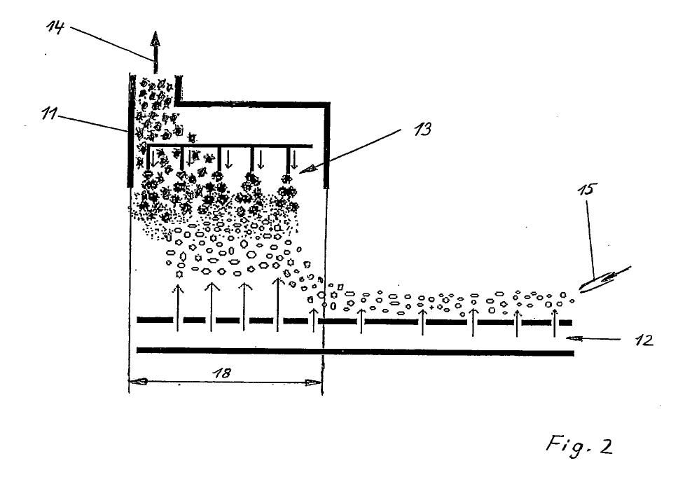

In the following the invention should be explained on the basis of two preferred forms of the procedure with reference to FIGS. 1 and 2.

FIG. 1 shows in a schematic cross-sectional view a device for the execution of a first form of the procedure according to the invention.

FIG. 2 shows in a schematic cross-sectional view a further device for the execution of a second form of the procedure according to the invention.

During the execution of the first form of the procedure according to the invention, shown in FIG. 1, a base material (6) or a mix of several base materials (6) solid at normal temperature in pulverized fine parted form is brought into a discontinuously loadable fluid bed reactor (1) by a pneumatic feeder (2) and held in the fluid bed by compressed air. At least one finely sprayed fragrance (7), liquid at normal temperature, is sprayed in form of an atomized spray against the base material particles (6) hold in the fluid bed, and the spray get in touch with the base material particles (6) for a certain period of time. Because of the close contact between the atomized spray droplets of the fragrance (7) and the surface of base material particles (6) hold in the fluid bed the atomized spray droplets (7) are adsorbed and/or absorbed by the pulverized fine parted base material (6) hold in the fluid bed. After saturation of the base material particles (6) hold in the fluid bed, they can be batchwisely carried out of the fluid bed reactor (1) by a discharger (4), which in case of the procedure shown in FIG. 1 is a vacuum discharger (4), and afterwards the fluid bed reactor (1) can be loaded with new base material (6) to be processed in the same way. The affecting time of the atomized spray (7) until the base material (6) is saturated is predominantly dependent on the chemical composition of the base material (6) and the fragrance (7) and can be determined empirically.

At specific base materials (6) and/or fragrances (7) the adsorption of fragrance (7) on the base material (6) can be improved by addition of an adhesive material for thereby increasing the quantity of fragrances to be adsorbed on the base material.

As at adhesive material carboxymethyl cellulose (CMC) for example is suitable. CMC is a solid material which can be added to the liquid fragrance in pulverized fine parted form and sprayed together with the fragrance, so that CMC can settle down exceedingly on the surface of the base material because of its intensive adhesive strength and adsorb the fragrance around the cores of the base material particles.

Other solid adhesive materials are soluble in the fragrance at normal temperature so that a fragrance-adhesive material-solution can be sprayed, and the adhesive material solidifies around the base material cores in the airflow of the fluid bed thereby adsorbing the fragrance or the fragrance mix, and thus also in this case due to the adhesive material dissolved in the fragrance larger quantities of fragrance can be adsorbed on the cores of the base material particles.

In a further example an additional adhesive material or an adhesive material mix is used which is solid at normal temperature, and must be dissolved in the liquid fragrance at a higher temperature. The fragrance-adhesive material-solution will be sprayed at the higher solution temperature against the base material or the base material mix hold in the fluid bed at normal temperature. In the fluid bed the atomized spray droplets consisting of the fragrance-adhesive material-solution cool on the base material particles, and in this way the adhesive material solidifies on the base material particles and adsorb the fragrance or fragrance mix. In this way it is possible to adsorb relative large quantities of fragrance or fragrance mix on the fine parted base material particles.

In the last mentioned procedure it is important to control the temperature of the fluid bed exactly for holding it at normal temperature. The adsorption of the fragrance is resulting from the changing of the state of aggregation of the adhesive material in the fragrance-adhesive material-solution due to the cooling in the fluid bed. The adsorption of the fragrance or the fragrance mix on the cores of the fine parted base material particles happens in a relative short time so that the changing of charges in the fluid bed reactor (1) can be carried through in short time intervals and thus large quantities of solid fragrance can be produced in a relative short term.

FIG. 2 is a cross-sectional view of a fluid bed reactor (11) suitable for continuous loading of pulverized fine parted base material for adsorbing and/or absorbing a liquid atomized spray of fragrance (13) around or in the pulverized fine parted base material or base material mix (6), which is hold in the fluid bed in a treating section (18) of the continuously loadable fluid bed reactor (11).

The feeding of the pulverized fine parted base material is carried through by a pneumatic feeder (15). The treating speed through the continuously loadable fluid bed reactor (11) is controlled by the pneumatic feeder (15) and a pneumatic discharger (14), and it is dependent on the saturation speed of the base material particles (6), as explained in detail in connection with the first form of the procedure.

In the continuously loadable fluid bed reactor (11) the adsorption of fragrance on the base material can also be improved by adding an adhesive material or adhesive material mix. This takes place principally in the same way as explained in detail in connection with the procedures according to FIG. 1.

The above invention has the advantage, that the fragrance or the fragrance mix can be adsorbed and/or absorbed by a pulverized fine parted base material without the necessity of subjecting the solid fragrance to a further modelling process, e.g. milling or grinding it at low temperature, etc.

1-12. (canceled)

13. A method for the production of a solid fragrance made of at least one at normal temperature liquid fragrance and at least one at normal temperature solid base material (6), wherein the at least one base material (6) in pulverized fine parted form is exposed to an atomized spray (7) of the at least one liquid fragrance in a fluid bed and the atomized spray is absorbed by the pulverized fine parted base material.

14. Method according to claim 13, wherein the base material in pulverized fine parted form (6) is batchwisely brought into a discontinuously loadable fluid bed reactor (1) and exposed to the atomized spray of fragrance (7) in the fluid bed for a defined period of time, and afterwards it is carried out of the reactor (1) by a discharger (4).

15. Method according claim 13, wherein the base material in pulverized fine parted form (6) is continuously input by a feeder (15) into a continuously loadable fluid bed reactor (11) and exposed to an atomized spray of fragrance (13) in a treating section (18) of the reactor (11), and at the end of the treating section (18), it is carried out by a discharger (14).

16. Method according to claim 13, wherein the base material in pulverized fine parted form (6) is a fatty alcohol or a fatty alcohol mix or a mix of fatty alcohol(s) with fatty acid(s) and/or fatty alcohol ethoxylene and/or a polyethylene glycol.
